(19) United States
(12) Patent Application Publication
(10) Pub. No.: US 2023/0030252 A1
(43) Pub. Date: Feb. 2, 2023

(54) Wireless Customer Solution Contract Renewal Program

(71) Applicant: Asurion LLC, Nashville, TN (US)

(72) Inventors: Guy Cartwright, Old Greenwich, CT (US); Pat Moody, Nashville, TN (US); Kelly Frazier, Nashville, TN (US)

(73) Assignee: Asurion LLC, Nashville, TN (US)

(21) Appl. No.: 17/553,572

(22) Filed: Dec. 16, 2021

Related U.S. Application Data
(63) Continuation of application No. 17/365,876, filed on Jul. 1, 2021, now abandoned.
Application No. 17/365,876 is a continuation of application No. 17/102,107, filed on Nov. 23, 2020, now abandoned.
Application No. 17/102,107 is a continuation of application No. 16/847,120, filed on Apr. 13, 2020, now abandoned.
Application No. 16/847,120 is a continuation of application No. 16/558,913, filed on Sep. 3, 2019, now abandoned.
Application No. 16/558,913 is a continuation of application No. 16/242,219, filed on Jan. 8, 2019, now abandoned.
Application No. 16/242,219 is a continuation of application No. 15/982,390, filed on May 17, 2018, now abandoned.
Application No. 15/982,390 is a continuation of application No. 15/589,073, filed on May 8, 2017, now abandoned.
Application No. 15/589,073 is a continuation of application No. 15/275,721, filed on Sep. 26, 2016, now abandoned.
Application No. 15/275,721 is a continuation of application No. 15/040,282, filed on Feb. 10, 2016, now abandoned.
Application No. 15/040,282 is a continuation of application No. 14/752,083, filed on Jun. 26, 2015, now abandoned.
Application No. 14/752,083 is a continuation of application No. 14/546,701, filed on Nov. 18, 2014, now abandoned.
Application No. 14/546,701 is a continuation of application No. 14/227,545, filed on Mar. 27, 2014, now abandoned.
Application No. 14/227,545 is a continuation of application No. 13/961,487, filed on Aug. 7, 2013, now abandoned.
Application No. 13/961,487 is a continuation of application No. 13/693,486, filed on Dec. 4, 2012, now abandoned.
Application No. 13/693,486 is a continuation of application No. 13/453,400, filed on Apr. 23, 2012, now abandoned.
Application No. 13/453,400 is a continuation of application No. 13/230,289, filed on Sep. 12, 2011, now abandoned.
Application No. 13/230,289 is a continuation of application No. 13/019,064, filed on Feb. 1, 2011, now abandoned.
Application No. 13/019,064 is a continuation of application No. 12/819,496, filed on Jun. 21, 2010, now abandoned.
Application No. 12/819,496 is a continuation of application No. 12/614,811, filed on Nov. 9, 2009, now abandoned.
(60) Provisional application No. 61/112,426, filed on Nov. 7, 2008.

(51) Int. Cl. G06Q 30/00; G06Q 30/02

(52) U.S. Cl. CPC G06Q 30/01; G06Q 30/0281

(57) ABSTRACT

A method for renewing device protection accounts is provided, the method including at least the receiving of a data file containing account information at predetermined intervals from a protection carrier; referencing the data file when an account subscriber contacts a provider; determining whether the subscriber is eligible for account renewal; and notifying said subscriber that account renewal eligibility has been determined.

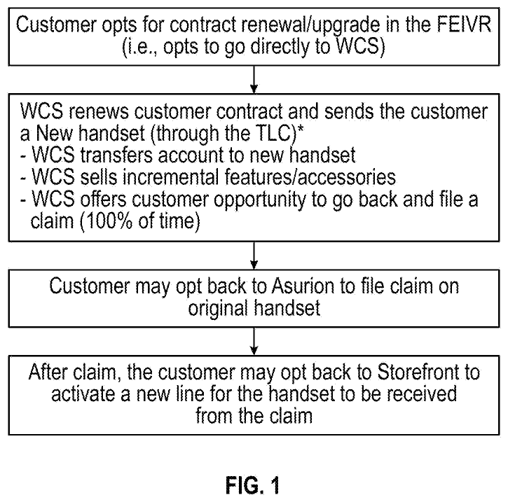

Wireless Customer Solution

Wireless Customer Solutions, Inc. (“WCS” or “Storefront”), a wholly-owned subsidiary of Asurion Corporation, was founded in early 2007 to more broadly leverage Asurion's interactions with consumers. In short, Storefront is a value-added sales organization that sells products and services directly to the consumer.

Contract Renewal Solution

Contract Renewal is designed to:
Provide a value added service that enables carriers to retain subscribers and build brand loyalty
Increase the revenue yield and margin contribution to WCS from existing subscribers
Incremental opportunity to market to subscribers since insurance subscribers are generally unlikely to visit a store after handset replacement
Provide a handset upgrade option to subscribers (prior to filing a claim or in lieu of filing a claim)

Contract renewal eligible subscribers will be presented with an option to hear more about renewing their carrier contract by the Asurion IVR, a touch tune/voice recognition system, when they call into Asurion to file a claim.

Daily, Asurion will receive a file from the carrier that contains information on subscribers eligible for contract renewal.

When the caller enters their 10-digit mobile number into the FEIVR system, eligibility will be determined and if the caller indicates they are filing a new claim, they will hear specialized messaging informing them that they are eligible to renew their carrier service agreement. At that point they will be prompted with an option to 1) talk to a WCS agent to renew their contract or 2) to continue filing an insurance claim. If the customer chooses to hear more about the contract renewal offer, then they will be transferred to a WCS agent. If they chose to file a claim, they will stay in the claim call flow path to hear the standard messaging.

The diagram below shows the subscriber routes for (1) filing an insurance claim or (2) hearing more about the carrier contract renewal option from a WCS sales agent.

Renewal Eligibility

Daily, Asurion will receive a file from the carrier that contains contract renewal eligible subscribers by mobile numbers. When the subscriber calls into the Asurion IVR system the system will look up the caller's mobile number to see if they are on the contract renewal eligibility list. If yes, the caller will hear specialized messaging pertaining to renewing their contract with the carrier.

The list of eligible subscribers is updated daily by the carrier and provided to WCS.

Note: WCS sales agents may be updating the carrier systems real time with the renewal transaction so these subscribers will fall off the carrier eligibility list m less than 24 hours.

Each WCS sales agent will confirm the subscriber's contract renewal eligibility by the carrier system at the beginning of the transaction. This carrier system contains all of the customer's wireless account and billing information in it.

Filing a Claim

Subscribers have the option to file a claim on their original handset per their insurance agreement before or after the carrier contract renewal transaction. The subscriber is presented with the claim filing option in the following circumstances:
1) by the IVR system when initially calling Asurion to file a claim
2) asking a WCS sales agent to be transferred
3) by the IVR system after completing the call with the WCS agent

No changes are necessary to the Asurion claim processing procedures in order for the subscribers to file a claim on the original handset. The Asurion claim verification department will confirm the claimed handset was active at the time of loss before processing the claim.

Customer Options

Contract renewal allows subscribers to renew their contract and take advantage of the carrier special offerings including an upgraded handset. Subscribers will have another option for their money besides paying for an insurance claim deductible. They can use the money on upgrading their handset with a renewal. The customer can upgrade to a more feature enhanced phone model and retain insurance coverage.

Insurance Coverage on the New Handset

The contract renewal transaction is independent of Asurion and/or the insurance claim processing transactions. WCS sales agents will complete the same process completed today by the carrier or other direct agents of the carrier. The customer will be offered to keep the existing account setup (including handset insurance).

Enrollment and Cost of Coverage
This service is provided to the subscriber at no additional monthly fee.
There is a contractual agreement between Asurion's fulfillment department and WCS for product fulfillment services.
When a consumer renews their contract their account information is updated directly in the carrier system.
When a consumer renews their carrier contract, the transaction is separate from their insurance policy.
The equipment will be “new”

Technical Requirements

Specific processes will be leveraged to manage the WCS Contract Renewal solution including:
Customer eligibility
   Data drip or look up required by the Asurion IVR system into a carrier provided file (listing all customers eligibility for a contact renewal).
Reporting:
   The IVR will provide reporting on the number of callers that opted to file a claim instead of hear about the renewal opportunity.
   The IVR will provide reporting on the number of calls interested in hearing about the renewal opportunity. The reporting goal is to know how many offers were presented vs processed (completed).
   The Asurion sales order system will provide numbers on renews completed by WCS sales agents.
   The Claim department will track the number of callers that filed a claim on their original handset after they get a new handset with a contract renewal.

1. A method for renewing device protection accounts, the method comprising:
receiving a data file containing account information at predetermined intervals from a protection carrier;
referencing said data file when an account subscriber contacts a
provider; determining whether said subscriber is eligible for account
renewal; and
notifying said subscriber that account renewal eligibility has been determined.
